(19) United States
(12) Patent Application Publication
(10) Pub. No.: US 2008/0194224 A1
(43) Pub. Date: Aug. 14, 2008

(54) EMERGENCY BROADCAST MESSAGE SUPPORT IN WIRELESS COMMUNICATION NETWORKS

(75) Inventors: Dean E. Thorson, Grayslake, IL (US); William P. Alberth, Crystal Lake, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/673,920

(22) Filed: Feb. 12, 2007

(51) Int. Cl. H04M 11/04; H04Q 7/20

(52) U.S. Cl. 455/404.1; 455/466

(57) ABSTRACT

A wireless communication network infrastructure entity (110) transmits a message, for example, a system parameters message, on a common signaling channel for reception by wireless terminals (102) in the network. The network entity also transmits an emergency broadcast message, for example, an SMS data burst overhead message transmitted on a paging channel. An emergency broadcast message information field of the message transmitted on the common signaling channel indicates the availability of the emergency broadcast message.

### FIELD OF THE DISCLOSURE

The present disclosure relates generally to wireless communications, and more specifically to emergency broadcast system messaging in wireless communication networks, for example, in CDMA-based systems, and corresponding methods.

### BACKGROUND

For homeland security, the United Sates Federal Communications Commission (FCC) is considering requiring cellular communication systems to support Emergency Broadcast System messages. Emergency Broadcast messages would be transmitted in the event of nationwide or local emergencies, for example, to report severe weather warnings, national or local disasters, terror alerts, etc. Many wireless communication systems support the communication of broadcast messages generally, for example, SMS, EMS and MMS messages. In some wireless communication systems, for example, the IS-2000 (CDMA) systems, however broadcast message signaling procedures have not been implemented very efficiently. Large scale broadcast messaging in these latter systems have a tendency to overwhelm messaging servers, often resulting in excessive delay in the delivery of messages to some recipients. Thus the use of SMS broadcast messaging to communicate emergency information using some broadcast signaling procedures is impractical, at least in applications where substantial delay is intolerable for at least some recipients.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a wireless communication system implementing messaging services.

FIG. 2 is a communication diagram between a network entity and a terminal.

FIG. 3 is a block flow diagram in a wireless infrastructure entity.

FIG. 4 is a block flow diagram in a wireless terminal.

### DETAILED DESCRIPTION

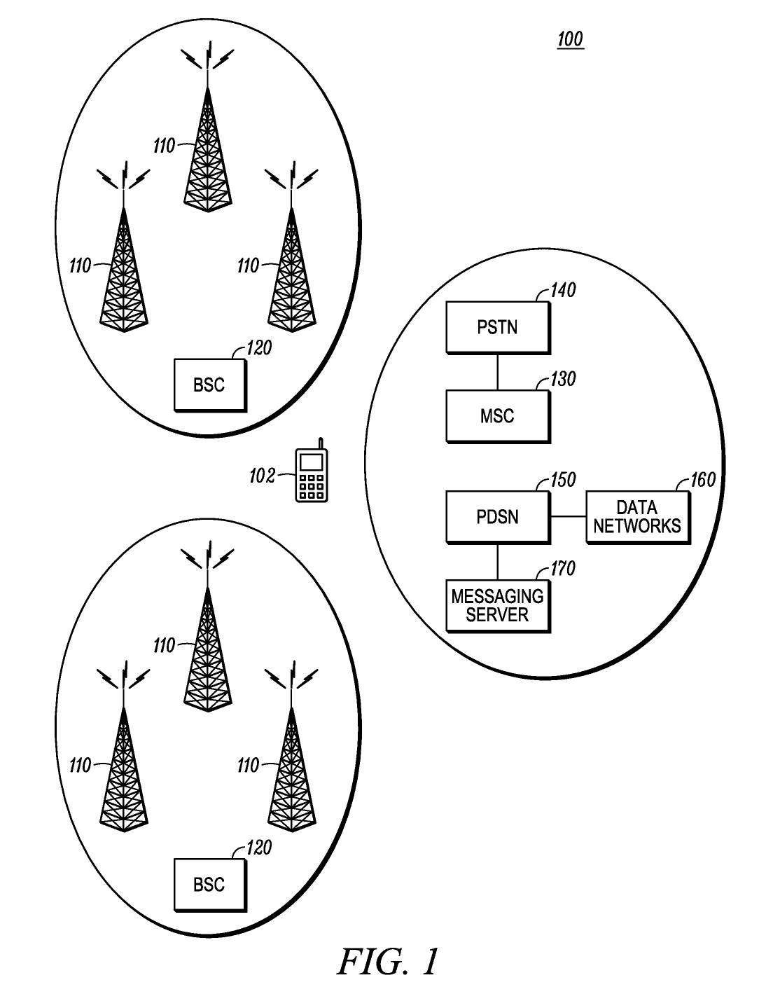

In FIG. 1, a wireless communication system 100 comprising one or more access networks communicably coupled to a core network. Alternatively, the wireless communication system could be implemented as a mesh network that eliminates the core network. In one embodiment, the system is a CDMA 2000 protocol network although in other embodiments the system may be compliant with some other communications protocol. In FIG. 1, the access networks each comprise one or more base stations 110 communicably coupled to a corresponding controller 120. The base stations provide wireless services coverage to a fixed or mobile wireless terminal or station 102 in geographical areas or cells, wherein the coverage areas of multiple cells or access networks may be aggregated to form location areas, which are typically defined by networks operators.

In FIG. 1, the core network comprises a Mobile Switching Center (MSC) 130 communicably interconnecting the access networks to switched networks 140, for example, to a PSTN. The core network also comprises a Packet Data Serving Node (PDSN) 150 communicably interconnecting the access networks to one or more data networks 160, for example, to an IP protocol network. The functionality of a CDMA 2000 PDSN is similar to that of the Serving GPRS Support Node (SGSN) and GPRS Gateway Serving Node (GGSN) entities in GSM and UMTS networks. The MSC is also typically communicably coupled to location registers, for example, to home and visitor registers and other network infrastructure entities well known to those having ordinary skill in the art. The wireless communication system 100 also comprises a messaging server 170 communicably coupled to the access networks and to the data networks in this example coupled via the PDSN.

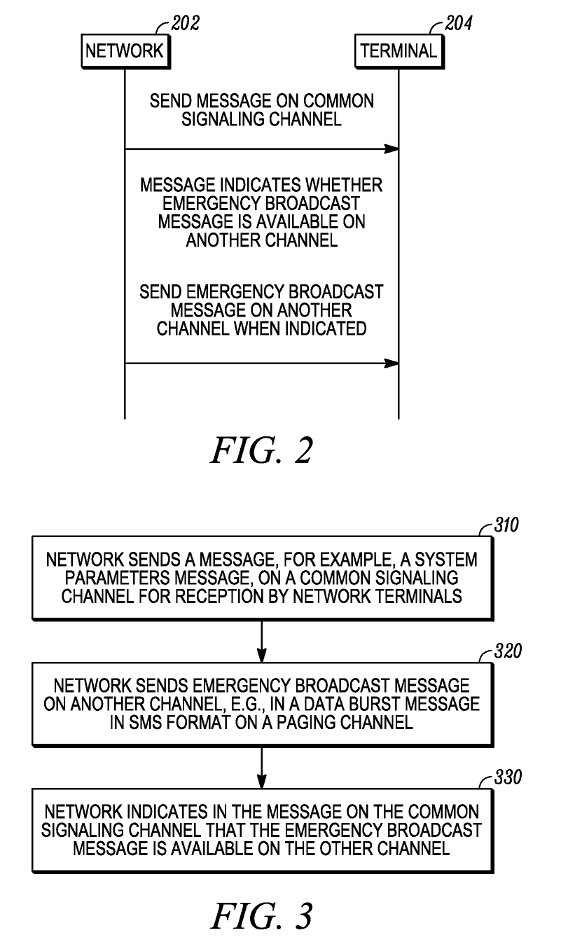

In FIG. 2, a network entity 202, for example, the base station 110 in FIG. 1, transmits a message on a common signaling channel for reception by a terminal 204. In one embodiment, the common signaling channel is a paging channel. The message includes an indication regarding the availability of an emergency broadcast message on the same channel. In one embodiment, the message includes an emergency broadcast message information field, for example, one or more bits, that indicates whether the emergency broadcast message is available on the same channel. Alternatively, the emergency broadcast message information field could be used to indicate that an emergency broadcast message is available on another (different) channel. The indicator bit or bits may be referred to as EMERGENCY_BROADCAST bits or indicator bits.

In one implementation where one or more indicator bits are used, the state of the emergency broadcast message bit indicates whether the emergency broadcast message is available. For example, a single bit set to “1” may indicate that the emergency broadcast message is available. Alternatively, the bit may be set to “0” to indicate the availability of the emergency broadcast message. Also, multiple bits may be encoded to specify one or more of several channels or sources where the emergency broadcast message may be obtained or accessed.

In one embodiment, the message on the common signaling channel is a system parameters message. For example, the system parameters may be a CDMA-2000 protocol System Parameters Message or a CDMA-2000 protocol Extended System Parameters Message. In one implementation, the emergency broadcast message information field may be an unused bit existing in the current CDMA-2000 System Parameters Message or in the current CDMA-2000 Extended System Parameters Message. In other implementations, one or more indicator bits in some other message on a common signaling channel may be used to indicate the existence or availability of an emergency broadcast message on the same or another channel.

In one embodiment, the emergency broadcast message information field of the message, for example, the system parameters message, transmitted on the common signaling channel indicates whether the emergency broadcast message is available on a paging channel. The paging channel on which the emergency broadcast message is transmitted may be the same as the paging channel on which the message containing the indicator bit is sent, or the emergency broadcast message may be sent on a different paging channel. In another embodiment, the emergency broadcast message information field of the message transmitted on the common signaling channel indicates whether the emergency broadcast message is available on a broadcast channel.

In one particular implementation, the emergency broadcast message is an overhead message, for example, an emergency broadcast overhead message on the paging channel. Alternatively, the emergency broadcast overhead message may be transmitted on a channel other than a paging channel. The overhead message is a type of message that is broadcast simultaneously to multiple terminals and must be read by all recipients.

In another particular implementation, the emergency broadcast message is transmitted as a data burst message on the paging channel. As noted, in some applications, the emergency broadcast message is an overhead message. In a more particular embodiment, the emergency broadcast message is a data burst message formatted as the SMS protocol message. Alternatively, the emergency broadcast message may be in an EMS or MMS protocol format or in some other message format.

In some embodiments, the emergency broadcast message may not have sufficient capacity to transmit all necessary information. For example, in embodiments where the emergency broadcast message is an SMS message, which is limited to 160 characters, the SMS message may have insufficient capacity to communicate the entire emergency message. Also, in some embodiments, it may be desirable to provide a link or pointer to another source where additional information is available. In embodiments where the additional information is optional, the terminal user may be prompted before accessing the additional information. And in embodiments where the additional information is mandatory, the terminal may automatically access the information. Thus in some embodiments, the emergency broadcast message may include information pointing to a location or channel where additional emergency broadcast information may be obtained or accessed.

In FIG. 3, from the perspective of the network infrastructure that originates communications sent to one or more terminals within the wireless communication system, at 310, the network sends a message, for example, a system parameters message, on a common signaling channel for reception by one or more terminals, for example, by mobile station 102 in FIG. 1. Network base stations and other infrastructure entities include radio transceivers capable of transmitting messages, including the modified system parameters messages and modified extended system parameters messages discussed herein.

In FIG. 3, at 320, the network sends emergency broadcast message on another channel, for example, in a data burst message in SMS format on a paging channel. At 330, the network indicates in the message sent on the common control channel that the emergency broadcast message is available on the other channel. The existence or availability of an emergency broadcast message may be indicated by the emergency broadcast message information field, wherein satisfaction of a condition by the indicator bit is indicative of the availability or existence of the emergency broadcast message on the paging channel as discussed herein. Alternatively, the indicator bit may be indicative of the availability or existence of the emergency broadcast message on the same common control message.

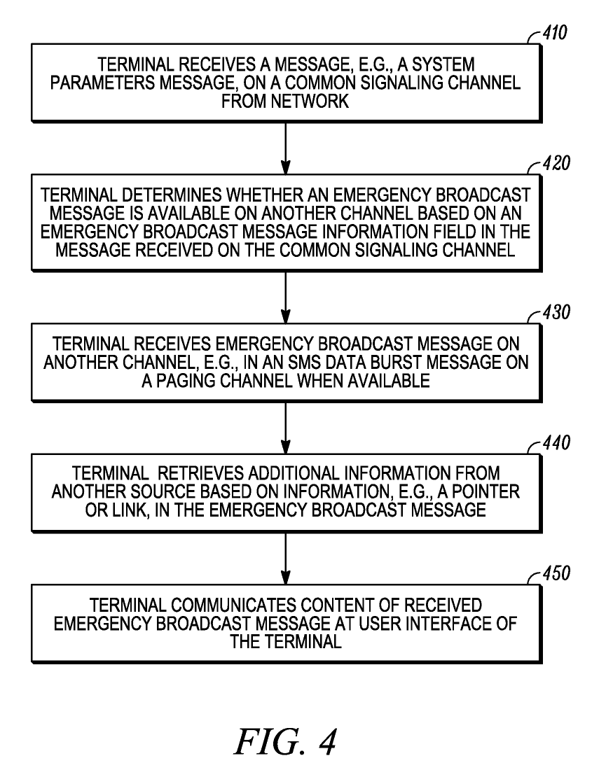

In FIG. 4, at 410, a wireless communication station, for example, the mobile station 102 in FIG. 1, receives a message on a common signaling channel from a network infrastructure entity, for example, from one of the base stations 110 in FIG. 1. As noted, the message may be a system parameters message or an extended system parameters message including an emergency broadcast message information field as discussed above. Wireless terminals also include radio transceivers capable of receiving messages, including the exemplary system parameters messages discussed herein.

In FIG. 4, at 420, the terminal determines whether an emergency broadcast message is available on another channel, for example, a paging channel, based on an emergency broadcast message information field in the message received on the common signaling channel. The emergency broadcast message information field indicates whether an emergency broadcast message is available on another channel based on the state of one or more bits, as discussed above. Alternatively, the emergency broadcast message information field indicates whether an emergency broadcast message is available on the same common signaling channel. The terminal may make such a determination via a processing device on the terminal.

In FIG. 4, at 430, the terminal receives an emergency broadcast message on another channel when the emergency broadcast message information field indicates that the emergency broadcast message is available on another channel. As discussed, the emergency broadcast message may be a data burst overhead message compliant with a messaging protocol, for example, the SMS format. Optionally, at 440, the terminal retrieves additional information from another source based on information, for example, a pointer or link, in the emergency broadcast message. At 450, the terminal communicates content of a received emergency broadcast message at a user interface. For example, the terminal may display a text message, and/or it may provide an audible or tactile alert. The message may also be played audibly. Alternately, the unit may otherwise take actions based on receiving the Emergency Broadcast System. For example, the terminal may send messages to other entities (forwarding emergency notice to another phone or person), and/or send data commands to another entity (sending commands to activate home security system).

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication station having a radio receiver and a user interface, the method comprising:
receiving a message on a common signaling channel,
the message including an emergency broadcast message information field indicating the availability of an emergency broadcast message;
receiving the emergency broadcast message if the emergency broadcast message information field indicates that the emergency broadcast message is available.

2. The method of claim 1, communicating content of a received emergency broadcast message at the user interface.

3. The method of claim 1,
the emergency broadcast message information field indicating whether the emergency broadcast message is available on a paging channel,
receiving the emergency broadcast message on the paging channel when the emergency broadcast message information field indicates that the emergency broadcast message is available on the paging channel.

4. The method of claim 1, receiving the emergency broadcast message as an SMS data burst message.

5. The method of claim 1,
the emergency broadcast message information field indicating whether the emergency broadcast message is available on a paging channel;
receiving the emergency broadcast message on the paging channel when the emergency broadcast message information field indicates that the emergency broadcast message is available on the paging channel,
the emergency broadcast message pointing to a location where additional emergency broadcast information may be obtained.

6. The method of claim 1,
receiving the message on the common signaling channel includes receiving a system parameters message on a paging channel,
the emergency broadcast message information field is an emergency broadcast message bit in the system parameters message.

7. The method of claim 6,
the emergency broadcast message is an emergency broadcast overhead message,
a state of the emergency broadcast message bit indicating whether the emergency broadcast overhead message is available on the paging channel,
receiving the emergency broadcast overhead message on the paging channel when the state of the emergency broadcast message bit satisfies a condition.

8. The method of claim 7, receiving the emergency broadcast message as an SMS data burst message.

9. The method of claim 6,
a state of the emergency broadcast message bit indicating whether the emergency broadcast message is available on the paging channel,
receiving the emergency broadcast message on the paging channel when the state of the emergency broadcast message bit satisfies a condition,
the emergency broadcast message pointing to another location where additional emergency broadcast information may be obtained.

10. The method of claim 1,
receiving the message on the common signaling channel includes receiving an extended system parameters message on a paging channel,
the emergency broadcast message information field is an emergency broadcast message bit in the extended system parameters message.

11. The method of claim 10,
the emergency broadcast message is an emergency broadcast overhead message,
a state of the emergency broadcast message bit indicating whether the emergency broadcast overhead message is available on the paging channel,
receiving the emergency broadcast overhead message on the paging channel when the state of the emergency broadcast message bit satisfies a condition.

12. The method of claim 11, receiving the emergency broadcast message as an SMS data burst message.

13. An IS-2000 wireless communication mobile station, comprising:
a radio receiver;
a processor communicably coupled to the radio receiver;
the receiver receiving a system parameters message on a common signaling channel, the system parameters message including an emergency broadcast message information field,
the processor determining whether an emergency broadcast message is available based on a state of the emergency broadcast message information field,
the receiver receiving an emergency broadcast message if the emergency broadcast message information field satisfies the condition.

14. A method in a wireless communication base station entity, the method comprising:
transmitting a message on a common signaling channel;
transmitting an emergency broadcast message;
indicating, in an emergency broadcast message information field of the message transmitted on the common signaling channel, the availability of the emergency broadcast message.

15. The method of claim 14,
transmitting the message on the common signaling channel includes transmitting a system parameters message on a paging channel,
the emergency broadcast message information field is an emergency broadcast message bit in the system parameters message.

16. The method of claim 15,
the emergency broadcast message is an emergency broadcast overhead message,
transmitting the emergency broadcast overhead message on the paging channel,
indicating that the emergency broadcast overhead message is available on the paging channel using the emergency broadcast message bit.

17. The method of claim 16, transmitting the emergency broadcast overhead message as an SMS data burst message on the paging channel.

18. The method of claim 15,
transmitting the emergency broadcast message on the paging channel,
indicating that the emergency broadcast message is available on the paging channel using the emergency broadcast message bit,
the emergency broadcast message pointing to another location where additional emergency broadcast information may be obtained.

19. The method of claim 14,
transmitting the message on the common signaling channel includes transmitting an extended system parameters message,
the emergency broadcast message information field is an emergency broadcast message bit in the extended system parameters message.

20. The method of claim 19,
the emergency broadcast message is an emergency broadcast overhead message,
transmitting the emergency broadcast overhead message on a paging channel,
indicating that the emergency broadcast overhead message is available on the paging channel using the emergency broadcast message bit.
